(19) United States
(12) Patent Application Publication
(10) Pub. No.: US 2025/0200706 A1
(43) Pub. Date: Jun. 19, 2025

(54) SYSTEMS AND METHODS FOR TRANSFORMING MEDIA ASSETS

(71) Applicant: Adeia Guides Inc., San Jose, CA (US)

(72) Inventors: Ning Xu, Irvine, CA (US); Tao Chen, Palo Alto, CA (US); Serhad Doken, Bryn Mawr, PA (US)

(21) Appl. No.: 18/545,142

(22) Filed: Dec. 19, 2023

(51) Int. Cl. G06T 5/20; G06F 21/60; G06T 3/40; G06T 5/60; G06T 5/70; G06V 20/30; G06V 20/62; G06V 40/16

(52) U.S. Cl. CPC G06T 5/20; G06F 21/604; G06T 3/40; G06T 5/60; G06T 5/70; G06V 20/30; G06V 20/62; G06V 40/162; G06T 2200/24; G06T 2207/20081; G06T 2207/30201

(57) ABSTRACT

The present disclosure describes methods and systems for executing transformations on media assets according to a time period or other schedule within a social media network infrastructure. It involves applying transformations to media assets to obscure content over time.

### BACKGROUND

The application is related to systems and methods for executing transformations on media assets within a social media network infrastructure.

### SUMMARY

In today's digital landscape, social media platforms and content-sharing services play a central role in communication and information sharing. In some approaches two types of media storage are utilized: permanent storage and temporary storage. Permanent media (e.g., after being uploaded to a sharing platform) remains static and unchanging, leading to accumulation of multiple full-size media assets in storage over time, which can lead to large permanent storage costs. Also, transmission of such full-size content imposes large bandwidth costs. Permanent storage of media also elevates security risks due to an ever-increasing digital footprint. For example, a high-resolution image of a face for extended periods of time is an identity theft risk, if such data is hacked or leaked.

On the other hand, temporary media, also referred to as “disappearing” media, exists for a limited time (e.g., 10 or 15 minutes) during which period it is accessible via a social network, before being automatically and permanently deleted. While this feature may be useful for preserving privacy, such deletions may result in the loss of important data (e.g., memories or moments). Both of these approaches fail to provide a flexible solution that allows for both preservation of data, reduction of storage and bandwidth usage, and increased security.

To help address these problems, systems and methods are provided herein for transforming stored media assets within a social media network. Example methods disclosed herein include receiving a media asset (e.g., photo or video, or another suitable media asset) at a server (e.g., a server of a social media network). In some embodiments, the server then provides the original version of the media asset for access across the network (e.g., via a feed of the original uploader). In some approaches, the server determines both the type of transformation applicable to the media asset and the time period for its application. For example, the server may receive user input specifying the type and timing of the transformation. In another example, the server may analyze (e.g., using suitable computer vision algorithms) the image to identify the type and timing of the transformation.

In some approaches, the applied transformations result in new versions of the media assets that occupy less storage space than their originals. For instance, when a server applies a blur effect to a high-definition photo, the resulting blurred image will require less bits for storage because blurred images are more compressible with suitable image compression techniques (e.g., JPEG compression). In certain scenarios, once the server creates this space-efficient transformed version, the server may delete the original media asset from the server's non-transitory memory, further optimizing storage utilization.

In some embodiments, after the determined time period has elapsed, only the transformed media asset is provided by the server for access by a plurality of devices via the social media network while the original version of the media asset is made unavailable by the server (e.g., due to deletion of the original version from storage managed by the social media network). The transformed media asset provided by the server for access by a plurality of devices via the social media network is less storage-intensive, yet sufficient for user engagement thereby significantly reducing the storage space required on the platform's servers without requiring permanent deletion of content.

In some embodiments, transformations may be achieved through various suitable techniques. For example, a high-resolution image, when transformed into a lower-resolution version, occupies less storage due to fewer pixels being stored. This process might involve downscaling the resolution while maintaining a balance between image clarity and file size. In terms of video content, the transformation might include reducing frame rates, applying compression codecs, changing color to monochrome or converting high-definition (HD) videos to standard-definition (SD) versions, each contributing to substantial reductions in file size. Reducing the data size also helps to reduce the bandwidth in transmitting the content to other devices.

In some examples, transformed media assets are less likely to compromise privacy of the users (e.g., a blurred face cannot be used for identity theft even if a malicious 3^{rd} party gains unauthorized access to such data).

In some examples, security risks associated with the storage of uncensored or sensitive media assets are mitigated by transforming images and videos to less detailed versions. For example, potentially sensitive information such as facial features or text (e.g., license plate numbers), is obscured. This may enhance privacy for individuals and entities featured in the media assets and may also reduce the platform's liability in storing and managing such content.

In an example scenario, the techniques described herein are performed by a server of a social media network where users may frequently upload high-quality images. Without transformation, these images may quickly accumulate, demanding significant storage resources and posing potential security risks if they contain sensitive information. By transforming these images to lower-resolution or blurred versions after a certain period or based on user engagement metrics, the platform may effectively manage its storage capacity. For instance, an image initially uploaded in 4K resolution could be automatically downscaled to 1080p after it receives a certain number of views or after a specific time period, and further to 720p as time progresses, or as user engagement decreases.

In one approach, systems and methods incorporate algorithms to analyze the original media asset for specific elements like facial regions and textual content. This may be achieved using a blend of computer vision and machine learning techniques. For instance, facial region detection algorithms like convolutional neural networks (CNNs) may be used. For text detection, optical character recognition (OCR) algorithms may be employed. These algorithms scan the media asset for patterns that resemble text, taking into account factors such as font variations and background contrast. Such processes may be executed either on the server of the social media network or locally on the user's device, depending on the system's architecture. The outcome of this analysis may guide the subsequent transformation process, ensuring that sensitive elements like faces or personal information are appropriately obscured to enhance privacy and security.

In some examples, the server is configured to receive user interface input (e.g., from a user interface of a social media application installed on a user device) specifying both the type of transformation and the time period for its application. This may allow users to have a degree of control over how and when their media assets are transformed, tailoring the process to their personal preferences or specific requirements for the content they share on the social media platform.

In some examples, systems and methods comprise identifying a series of sequential transformations and setting time periods for their application. Each transformation may incrementally reduce the storage space required for the media asset, ensuring that only the most recent version is available for network access. This phased approach to transformation may allow for gradual and controlled alteration of the media asset.

In one example, the sequential transformations include applying a filter that transforms pixel data of the media asset to obscure its content. The intensity of the filter may be increased with each transformation (e.g., by applying the filter again with parameter settings of an increased strength over the previously transformed version of the media asset), reaching a maximum level (e.g., a predetermined amount). This method may effectively alter the media asset's appearance, enhancing privacy and security while maintaining its recognizability and reducing storage requirements.

In some examples the strength of the filter applied remains constant during each transformation. For instance, applying a consistent gaussian blur filter repeatedly results in progressively more obscured content.

In some embodiments, a stable diffusion model is used to transform the media asset. This model introduces a specific amount of noise in a controlled and stable manner, applied recursively. Each iteration of the model incrementally increases the noise level, gradually transforming the image.

In some embodiments, following the receipt of a media asset for sharing, a target stylized representation is generated. This may involve analyzing the original version to extract distinctive visual elements (e.g., facial regions or text) as feature vectors and using these to create a stylized version via an image generative machine learning model. Once complete, this process changes the media asset from the original to a representation of the original, offering visually appealing and storage-efficient versions of the original media asset.

In some examples, systems and methods comprise using a facial recognition algorithm to identify facial regions within the media asset, segmenting these regions, and selectively applying the transformation. This targeted approach may ensure that sensitive personal identifiers are specifically addressed in the transformation process, enhancing the privacy of individuals depicted in the media asset.

In one example of the disclosure, determining the time period for applying the transformation involves monitoring the access frequency of the media asset and determining an access rate. Based on this rate, the system may decide the optimal timing to apply the transformation, ensuring that the content is updated in alignment with user engagement and interest levels. For instance, a schedule for applying transformations may be based on the access rate crossing a given threshold, e.g., transformations may be applied when the access rate changes by a certain percentage, such as decrease (or increases) by 50%.

In some approaches, systems and methods comprise, at the server of the social media network, embedding metadata associated with the transformation into the transformed version of the media asset (e.g., the transformation type and the time period applied). Upon access to the media asset (e.g., by another device associated with the social media network), this metadata is retrieved, and instructions are provided to maintain or reapply the transformation, ensuring consistency of the transformed media asset across different devices and over time (i.e., so that the shared media asset is transformed at the same time across multiple devices). This feature adds an additional layer of control and consistency to the transformation process, maintaining uniformity in how the transformed media asset is presented and accessed across the social media network.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIG. 1 shows an example framework for managing media asset transformations within a social media network environment;

FIG. 2 depicts an example of a selective transformation of media assets based on content analysis within a social media network environment, in accordance with some examples of the disclosure;

FIG. 3 depicts an example sequential transformation of a media asset managed on a social media network, in accordance with some embodiments of this disclosure;

FIG. 4 presents an exemplary user interface within a social media application, in accordance with some embodiments of this disclosure;

FIG. 5 illustrates an example user interface 515 within a social media network server displayed on a user device, in accordance with some embodiments of this disclosure;

FIG. 6 presents an example user interface on a social media application, in accordance with some embodiments of this disclosure;

FIG. 7 is a flowchart representing an illustrative process for transforming media assets according to a time period, in accordance with some embodiments of this disclosure;

FIG. 8 resents an example scenario illustrating the transformation of media assets stored within the local storage of a user device, in accordance with some embodiments of the disclosure;

FIG. 9 is a block diagram showing components of an example system for transforming a media asset according to a time period, in accordance with some examples of the disclosure.

### DETAILED DESCRIPTION

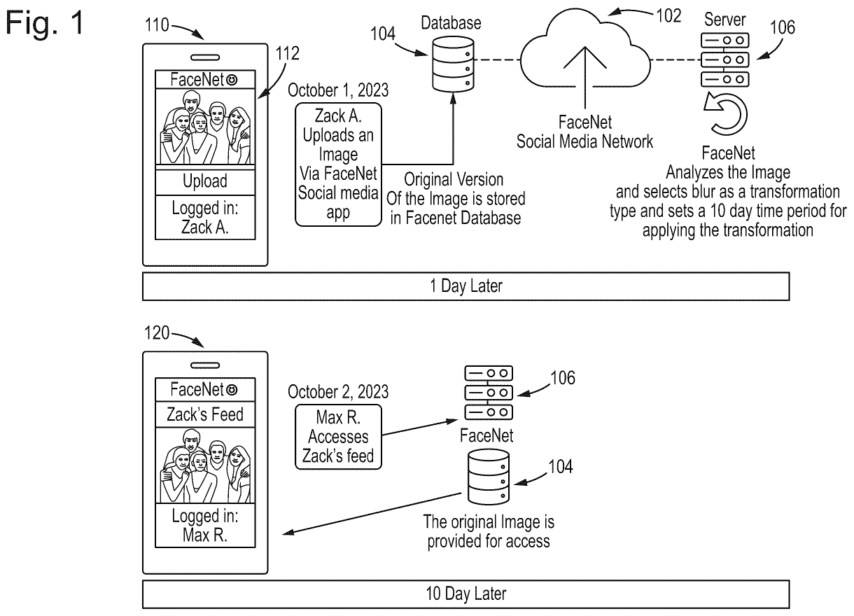

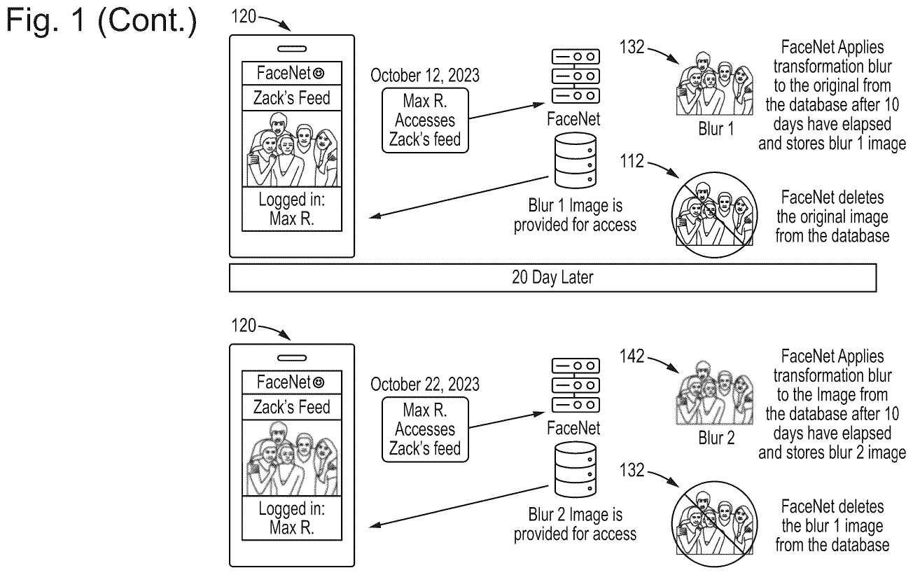

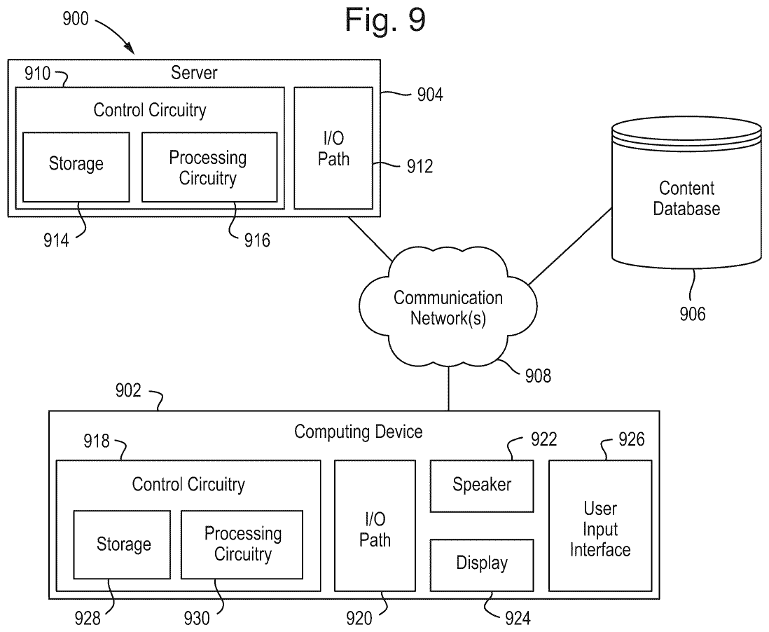

FIG. 1 illustrates an example framework for managing media asset transformations within a social media network environment, comprising social media network 102, database 104, and server 106. Server 106 (comparable to server 904 in FIG. 9) functions as a central processing unit. It is equipped with control circuitry (comparable to control circuitry 910 in FIG. 9) which may include storage (comparable to storage 914 in FIG. 9) and processing circuitry (comparable to processing circuitry 916 in FIG. 9). The control circuitry of server 106 may control operations such as the reception, analysis, and transformation of media assets, which may include images, videos, or audio clips. Server 106 may operate either independently or as part of a server cluster, addressing the demands of network traffic, data processing, and storage within the social media network. The control circuitry of server 106 receives the user requests that are characteristic of a social media environment (e.g., uploading and sharing media assets). It is responsible for executing algorithms for content analysis and identifying suitable transformations to apply to media assets.

In some examples, user device 110, such as a smartphone, tablet, or personal computer, is a device used to interact with the social media network. It is the interface through which media assets are uploaded to the server 106. User device 110 incorporates necessary hardware components for this purpose (comparable to the computing device 902 depicted in FIG. 9). This may include processors, storage, and input/output circuitry for managing settings, viewing content, and interacting with the social media network.

For example, the user device 110 interacts with the social media network 102 via a social media application or a web browser installed the user device. The social media application translates user inputs (e.g., via a user interface of the social media application or website) into instructions that are sent to and executed by server 106. Through either the application or web browser, various media assets may be uploaded to the server 106, which the server then receives and processes.

In some examples, database 104 (comparable to storage unit 914 in FIG. 9) functions as a storage repository within the social media network. It is configured to store uploaded media assets (e.g., original and transformed versions of media assets). Database 104 works together with server 106 in storing the media assets that the server 106 processes and transforms.

In some examples, social media network 102 in FIG. 1 (comparable to the communication network 908 shown in FIG. 9) serves as the infrastructure for data transmission and connectivity within the framework for managing media asset transformations. Social media network 102 may comprise servers, databases, and other networking equipment to facilitate communication between user device 110, such as server 106, and database 104. The aforementioned example network architecture and similar network Configurations, enables the transfer and processing of data, including media assets and user requests, across the social media platform.

In an example shown in FIG. 1, server 106 receives a media asset 112 (e.g., images, videos, or audio clips) from a user device 110. The media asset 112 is transmitted to the server 106 of the social media network, for instance, through a social media application or web browser installed on the user device 110. The social media application, comprising elements such as a user interface for selecting and sending media, utilizes communication modules that enable data exchange with the server 106. For example, these modules may operate via protocols such as HTTP (hypertext transfer protocol) for web-based transmissions. The media asset, once successfully uploaded, is stored by server 106 within a database 104 that is part of the social media network, here represented as FaceNet. The media asset 112 is then available for subsequent transformation processes aimed at optimizing its storage and distribution on the FaceNet platform.

In some examples of the disclosure, upon receipt of the media asset, server 106 may present a transformation toggle within the user interface of the user device. The transformation toggle when switched to off, may deactivate subsequent transformation processes (i.e., so that a user preference not to transform may be applied to some media assets). The received media asset would remain in an original state (i.e., would not be subject to a transformation process). In some examples, switching the toggle to an on position initiates the following processes.

In some approaches, upon receipt of the media asset 112 at server 106, the media asset 112 is stored in database 104 as part of the FaceNet system, where it is initially stored in its original form (i.e., a non-transformed version). The server 106, equipped with analytical capabilities, for example, evaluating the media asset's content through algorithms capable of recognizing specific features such as facial regions or textual elements, determines a suitable transformation type for the media asset. An example of a suitable transformation is blur or pixelization, or a different transformation that best suits the identified content. Furthermore, server 106 might also decide the extent of transformation, possibly affecting only certain parts of the media asset 112 (e.g., facial regions or textual elements). The aforementioned process may be fully automated, with server 106 or other integrated system components autonomously performing the analysis. In some examples, the system may allow users to input their preferred transformation settings more directly via the user interface of the application installed on the user device 110.

In some embodiments, Server 106 also determines a time period for the application of the transformation. For example, the time period may be determined by monitoring social media metrics associated with the media asset 112 (e.g., a number of views or likes) or user-specified preferences (e.g., a specified number of days). The time period may be implemented by initiating an update timer or a similar scheduling mechanism within, for example, a software framework of the server 106. For instance, in the illustrative scenario of FIG. 1, Zack A.'s uploaded image might be scheduled for a blur transformation to be applied after a 10-day period.

In some examples of the disclosure, following the determination of the transformation time period, as in the case of Zack A.'s image scheduled for a blur transformation after 10 days, the social media network 102 facilitates requests related to the media asset. For example, as depicted in FIG. 1, a day after Zack A. uploads image 112, a request from a second user device 120, where the second user device 120 is logged into the social network using an account of Max R., seeks access to Zack A.'s social media feed. In response to this request, server 106 retrieves the original version of the image from database 104, since the set time period for the initial transformation has not yet lapsed. In this example, the server 106 provides access to the original media asset 112 before the commencement of the transformation process, such that users may view the unaltered content within the designated time period.

In some examples, after the time period has elapsed 10 days following the initial upload, server 106 receives another request to view Zack A.'s image. At this point, aligning with the previously established time period for transformation, server 106 retrieves a modified version of the image, now identified as image 132. This image has undergone its first transformation, exhibiting a degree of blur. Each applied transformation results in a reduction of the required storage space for the media asset, with image 132 representing the updated state of the asset.

In another example, depicted within FIG. 1 a continued progression of the transformation process is shown. Twenty days post-upload, another access request to view Zack A.'s image is processed by server 106. The server 106, adhering to the transformation time period, retrieves the latest version of the image, labeled as image 142. This version exhibits an enhanced level of transformation, displaying a more pronounced blur effect. Image 142, embodying the latest transformation, supersedes the previous versions and is the one made available for user interaction via the social media network, ensuring that the most recent and storage-efficient version of the media asset 112 is utilized. In this way, the server 106 may opt to stop after one transformation period or continue to apply the transformation after every 10-day period. The determination on whether to stop or continue may be based on a user input (e.g., user setting specifying the number and degree of transformations).

In some approaches, once the transformation process reaches its conclusion in accordance with the determined time period (e.g., when a maximum level of transformation is achieved), the final version of the media asset 112 is retained as a more secure version compared to the original. For example, by this stage, any identifiable features like the faces of subjects visible in the original media asset 112 have been sufficiently obscured and any sensitive text rendered unreadable, enhancing the security and privacy of the content. Despite these changes, the final version of the media asset 112 remains accessible on the social media network 102 and retains enough of its original essence to be recognizable by those familiar with it. This balance ensures that while the media asset 112 now occupies less storage space and presents a minimized privacy risk, it still serves its purpose as a recognizable and meaningful piece of content for associated users.

In some examples, subsequent to the transformation process, server 106 may employ varying strategies for managing the original media asset 112 or the media asset 112 which precedes the most recent transformation. The server 106 may be configured to retain the original version of the media asset, particularly for retrieval by the original uploading device or account, in a secure and possibly less accessible storage, such as a restricted area of a cloud storage for example.

In some examples of the disclosure, the server 106 may be configured to permanently delete the original media asset 112 once the transformation has been applied, to conserve storage resources. In such instances, only the most recently transformed version of the media asset 112 would persist on the social media network.

The examples presented in this disclosure are illustrative and not exhaustive. Components such as social media network 102, server 106, database 104, user device 110, and the methods and systems for managing media asset transformations, represent just a few of the many ways these elements may be configured and utilized within the scope of this disclosure. Each component, such as servers, social media networks, time periods, transformations, and user interfaces, can be employed individually or in various combinations, depending on the specific requirements and objectives of the social media platform. Furthermore, different embodiments of the disclosure may pursue different goals, catering to varying priorities. For example, one embodiment might be specifically configured with a focus on enhancing security while another embodiment might prioritize minimizing storage requirements of the media asset.

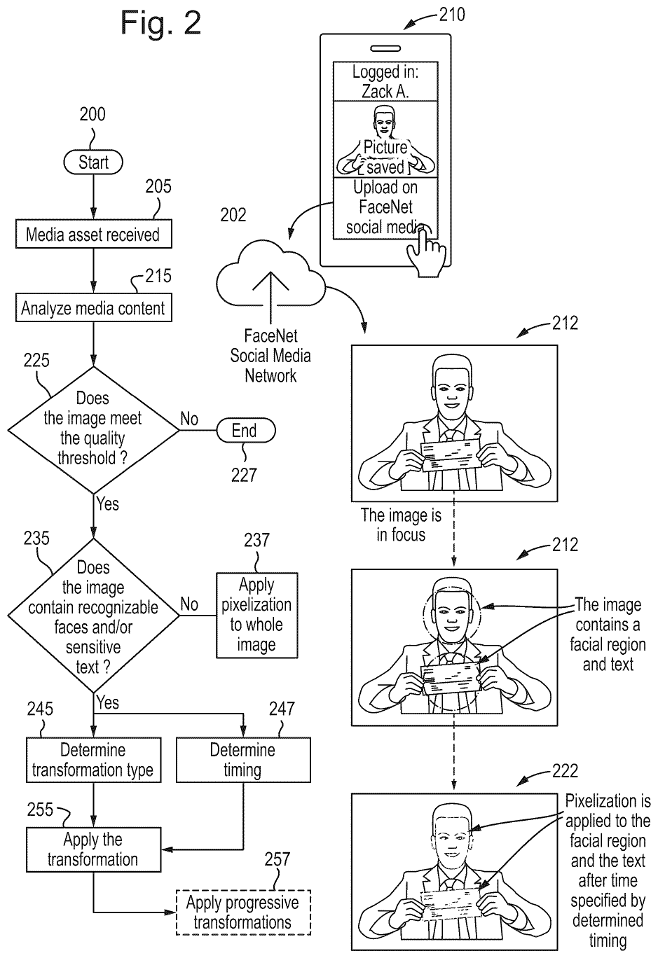

FIG. 2 depicts an example of a selective transformation of media assets based on content analysis within a social media network environment, initiated at 200. Here, a server of the social media network, as introduced in previous discussions, receives a media asset at 205. The example is illustrated with a user device 210, shown as uploading a media asset 212 to the FaceNet social media network 202.

In some examples of the disclosure, the server conducts an analysis of the media asset shown at 215 in FIG. 2, to assess its quality. For instance, the server (e.g., server 904) may evaluate whether the media asset (e.g., image 212) meets predetermined quality criteria 225 (e.g., resolution, contrast, color fidelity, noise levels, or the presence of motion blur). For instance, the server might deploy image recognition algorithms that scan for common indicators of image quality, including the sharpness of edges (e.g., to detect blur) or the level of detail in low-light conditions (e.g., to assess exposure). If the media asset fails to meet the quality threshold, as determined at 227, the analysis may stop, and no transformation is applied to the media asset.

In some implementations, the server (e.g., server 904) may display a notification on the user device that uploaded the media asset 212 (or a different device logged in as the user account used to upload the media asset), prompting for user input on whether to proceed with the upload without applying a transformation. Additionally, the server may elect to store the media asset in its original form, foregoing any transformation and maintaining the media asset as unaltered within the social media network's database.

In some approaches, the server may further analyze the media asset, shown at 235 to detect the presence of, for example, identifiable facial features or textual content. If no such features are detected, a generic transformation may be applied to the entire image shown at 237. Conversely, if the server identifies facial regions or text, an appropriate transformation type may then be determined at step 245. The server's determination of the transformation type may take into account various criteria, which may include user-defined preferences. For example, the server might select pixelization for facial regions to obscure the identity of subjects detected in the media asset, while opting to crop or completely remove text, followed by proper inpainting to ensure an appreciable visual appearance. The server may concurrently determine a time period for the application of such transformations (e.g., shown at 247).

In some examples, the server, after applying the transformation 255 in alignment with the predetermined time period may initiate a series of progressive transformations 257, which may be dictated by the user's settings (e.g., settings that specify the incremental intensity or type of transformation over time) or the nature of the media asset's engagement on the social media platform (e.g., including but not limited to view counts, achievements/awards or engagement rates of the media asset). For instance, the server (e.g. server 106 or 904) might utilize a scheduling algorithm that triggers transformation updates when the media asset reaches certain engagement thresholds. Alternatively, if user settings dictate, the server might apply transformations at regular intervals, regardless of engagement levels, to progressively modify the media asset, ensuring that each version requires less storage and aligns with the user's privacy preferences.

The outcome of this selective transformation example depicted in FIG. 2 is depicted in the transformed media asset 222, where the facial region and text have been suitably obscured by pixelization.

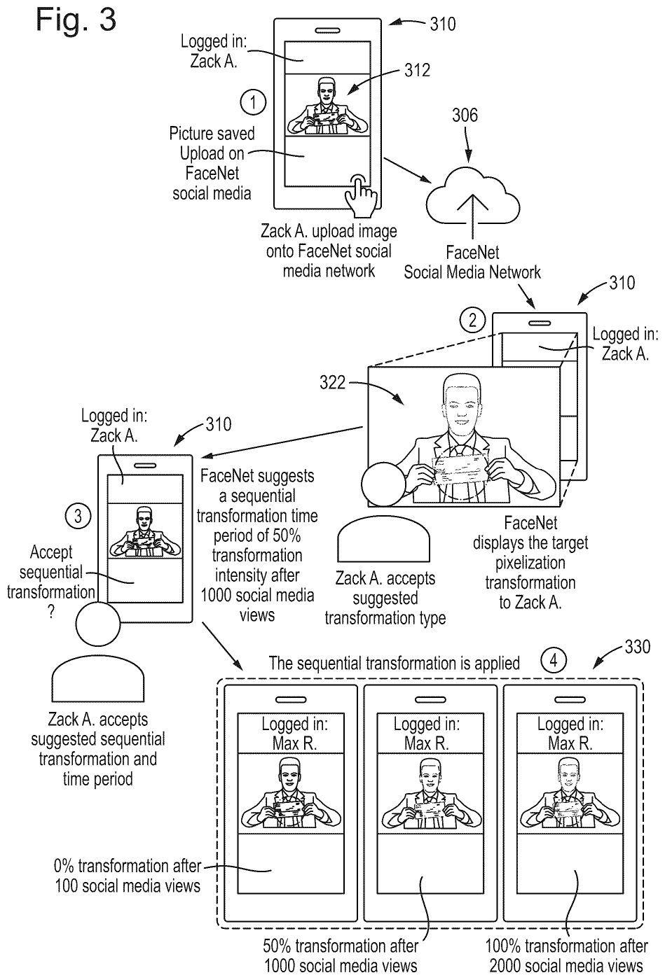

FIG. 3 depicts an example sequential transformation of a media asset managed on a social media network. Beginning at step 1, a user device 210, is logged into a user account, here represented as an account belonging to Zack A. Media asset 212 is uploaded to the server of the social media network 202. As discussed previously, the upload may be facilitated through a user interface of an application specific to the social media platform, which communicates with the network's server using data transmission protocols.

In some embodiments, upon successful upload, the server receives the media asset and begins the process of determining a suitable transformation type. In some approaches, the server 306 may generate a preview of the proposed transformation, displayed as item 322 on the user device 310.

In one approach, the analysis, aimed at determining an appropriate transformation type, may occur directly on the server (e.g., server 106 or 904). In some approaches, however, the server may send instructions to the user device 310 via the social media application to carry out the analysis at the user device (e.g., using processing circuitry of the user device). This allows the user device to locally process the media asset and apply a potential transformation. In the example depicted in FIG. 3, a preview of the transformed media asset is shown on a device logged in as Zack A. The server may instruct the user device to temporarily store the preview media asset (e.g., at a storage of the user device) until for example, a user input is provided regarding the acceptance or rejection of the previewed transformation.

In some implementations, illustrated at step 2, generation of this preview on the user device 310 involves the application of a non-permanent transformation (i.e., not uploaded onto a social media feed) to the media asset, simulating the final appearance after the transformation is applied. The preview provided at the user device a visual representation of the potential outcome post completion of the transformation process. In some examples, multiple transformation options may be provided (e.g., displaying the results from different transformation types side by side) at the user device, allowing, the most desirable outcome to be selected. This example may involve interactive elements on the user interface of the social media application.

In some embodiments, as shown in step 3, the server displays a notification at the user device of a determined time period for when the transformation will be applied. The server may present various configurable options for Zack A. to select from (e.g., adjusting the time period or delaying the initial transformation), allowing for personalized control over the transformation time period.

In some embodiments of the disclosure, when establishing a time period for transformation at step 3, the server (e.g., server 106 or 904) may opt for a strategy involving sequential transformations of the media asset (e.g., 312). This approach entails applying the transformation across multiple steps, with each subsequent transformation building upon the last (i.e., using the most recently transformed version of the media asset), or applying each new transformation to the originally uploaded version of the media asset (i.e., reapplying the transformation to the original asset by a different amount).

For example, at step 4, the server demonstrates how the media asset 312 would appear after each sequential transformation, as illustrated by item 330. For instance, if the chosen transformation is pixelization, the server might showcase a before-and-after effect, demonstrating the media asset at semi-completed stages.

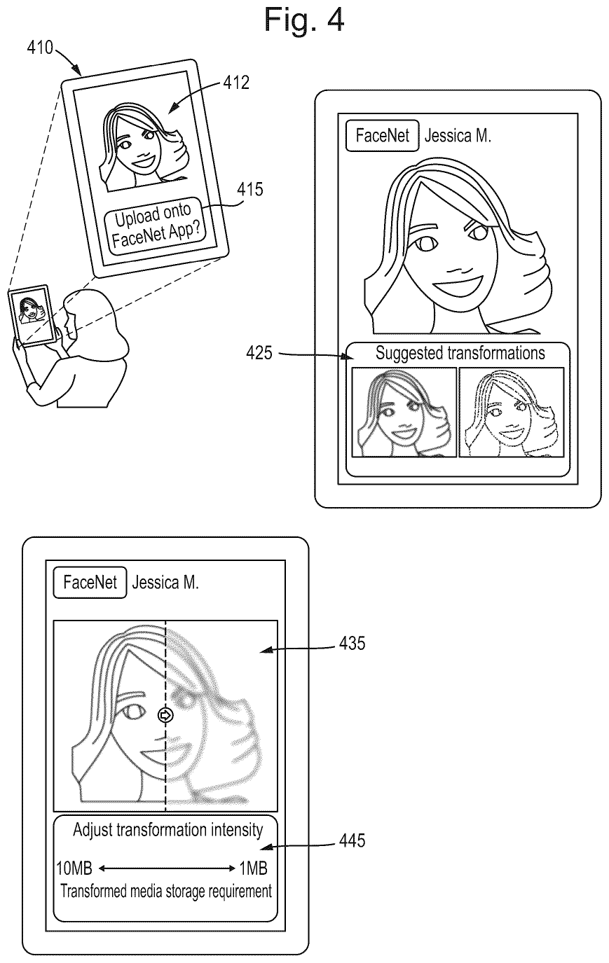

For example on the screen of the user device 310, the media asset 312 may appear in a split-view format, with one side depicting the current state and the other showing the asset after a 50% pixelization, once it hits 1000 views, and then fully pixelized after 2000 views. This is shown in greater detail in FIGS. 4 to 6. This preview function may allow a visualization of the gradual change displayed at the user device, and display, for example, the impact of user engagement on the appearance of the media asset on the social media network e.g., network 306.

In some examples, the server may incorporate popularity metrics of the media asset on the social media network to determine the application or reversal of transformations. For example, the server may implement a transformation policy where a transformation is applied when the number of views per time period (e.g., per hour or per day) of the media asset crosses a certain threshold, such as 1000 views in a day. In this scenario, a decrease in views below the threshold may trigger a transformation like pixelization or blurring to optimize storage space. In another example, if the media asset experiences a surge in popularity, with views exceeding a specified limit like 5000, the server might reverse or lessen the transformation, restoring the media asset to its original state. The server may utilize any number or combination of triggers, such as view counts, likes, shares, or comments, to apply or remove transformations.

FIG. 4 presents an exemplary user interface within a social media application. In some embodiments, a user device 410 (e.g., a smartphone, tablet, or personal computer) is used to interact with a social media application. This application, associated with a social media network such as FaceNet, serves as the interface through which users manage their digital content. In some embodiments, a media asset 412, is uploaded onto a server (e.g., server 106 or 904) of the social media network. Media assets may include a wide array of digital content forms including but not limited to photographs, video clips, audio recordings, and digitally created artworks.

In some scenarios, the user interface 415 on device 410 affords multiple upload options at the user device 410. For instance, a user might opt to upload the media asset (e.g., 412) in its original state or choose to apply preliminary transformations such as cropping or resizing before the upload.

The server (e.g., server 106 or 904) may, for example, temporarily store the uploaded media asset 412 while awaiting an input of transformation settings. The server might also choose to retain a preview of the potential transformed media asset on the user device 410, allowing for a review period before finalizing transformation settings and the associated time period for their application. This interim preview may be useful in scenarios where multiple transformations are under consideration, or when feedback and approval via the user interface are required before committing to a transformation.

In some approaches, the server (e.g., server 106 or 904) of the social media network, upon receiving the uploaded media asset 412, undertakes a series of analytical procedures to propose one or more transformations, depicted in FIG. 4 as item 425. These transformations may range from blur and pixelization (e.g., gaussian blur) to morphing the media asset to a stylized of the original version. For example, the stylization process might include transforming the original media into a cartoon or caricature version. This transformation may be achieved using generative AI models or applications with cartoon or stylization features. For instance, the original image may be input into an AI tool programmed to create a cartoon or other stylized version in a series of steps. Each step in this process progressively alters the image, leading to a variety of transformed versions of the original media asset, ranging from slightly modified to heavily stylized.

In some examples, the server identifies prominent objects within the uploaded media asset, such as faces or specific landmarks, using object recognition algorithms like convolutional neural networks (CNNs). This capability allows the server to isolate and target these objects for individual transformations. For instance, the server can selectively blur a person's face in a photo while keeping the background sharp, or it could apply different levels of stylization to various elements within the same image.

In some embodiments, A server of the social media network (e.g., server 106 or 904) may apply a transformation configured to imitate temporal progression to otherwise static media assets. For example, a digital image of a person (e.g., 412) may undergo a series of transformations that simulate natural aging. This may be achieved by applying image editing algorithms that incrementally adjust visual features such as facial lines, color tone, and texture to mirror the aging process over time. Similarly, an image capturing a cityscape might be transformed to integrate new buildings or urban developments, maintaining a current representation of the landscape. The server (e.g., 106 or 904) may, for example, be equipped with processing circuitry that utilizes image recognition to identify key features in the media asset (e.g., landmarks and buildings). Through a combination of image search and the application of generative models, the server may update to integrate new buildings over time.

In another embodiment, the server (e.g., 106 or 904) may apply a transformations that imitate the aging of media assets. For example, initially vibrant colors may be gradually desaturated, eventually transitioning the media asset to grayscale, comparable to the way physical media assets such as photographs fade and discolor over time. The technical execution of this process may involve iterative application of filters that reduce color saturation, modify contrast and brightness, and apply a noise layer to simulate the effects of aging on printed photos. Control circuitry of the server may execute these transformations by processing image data, recalibrating color values, and introducing graphical elements that represent the passage of time.

In some examples, the user interface (e.g., 425) may present configurable settings for the application of the transformation. In some implementations, a slider 435 is used as a control element through which user input may be received to dynamically adjust the intensity of the applied transformation, be it the degree of blur, the extent of pixelization, or the strength of a filter effect.

In other examples, the impact of each configurable setting on storage space is demonstrated through an indicator, shown as item 445 (e.g., a higher degree of blur leading to a reduced file size). This interface element may provide real-time updates on the expected storage savings associated with the chosen transformation level. For example, sliding towards a higher blur intensity may significantly reduce the image's storage footprint from 10 MB to a much lower 1 MB after compression, as visualized in the Figure.

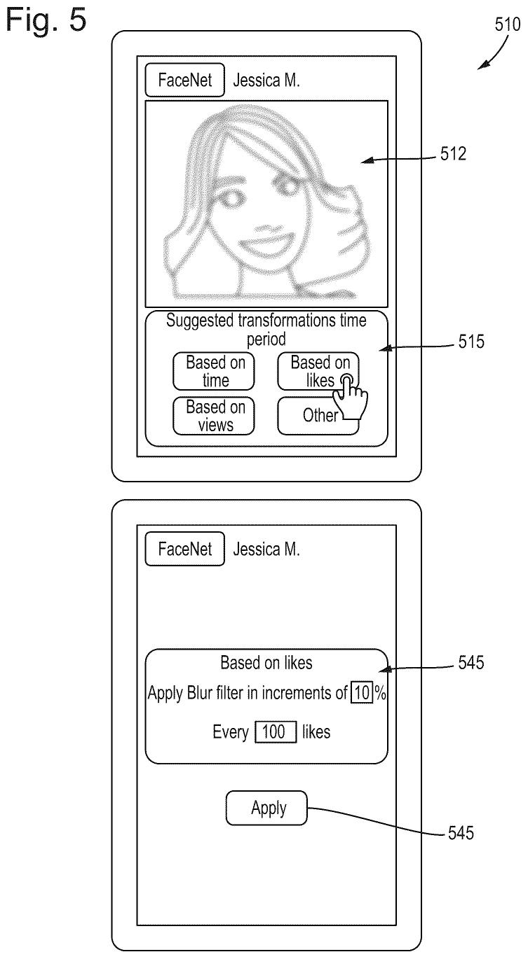

FIG. 5 illustrates an example user interface 515 within a social media network server displayed on a user device, configured for setting transformation parameters on media assets. The user interface 515 is displayed on a user device 510 and provides a means for the server (e.g., server 106 or 904) to acquire transformation scheduling instructions based on user interaction data (e.g., user input).

In some approaches, item 512 represents a media asset that has undergone a preliminary transformation (such as the transformation of FIG. 4). In the approach shown in FIG. 5, a real-time preview, generated by the server (e.g., server 106 or 904), is displayed at the user device 510 to illustrate the potential outcome of the transformation based on current configuration settings.

In some examples, the user interface 515 presents a set of triggers for the server to execute the transformation. These triggers are configured to initiate the transformation process based on a range of criteria (e.g., the number of views the media asset receives, the accumulation of ‘likes,’ or after a predetermined duration). This selection is not exhaustive; the server may be configured to accommodate various other triggers such as user engagement levels, specific date and time, or algorithmically determined optimal points for transformation application.

In some embodiments, a more granular configuration as depicted at 545 allows the user interface 515 to receive a user input which provides a mechanism for the server to obtain settings that dictate the transformation's granularity. For example, a user input allows the server (e.g., server 106 or 904) to configure the transformation intensity to incrementally apply based on ‘likes’ received. The interface component 545, when activated, commands the server to apply the detailed settings as specified by the user interaction data, thus customizing the transformation's intensity and application rate.

In an example shown in FIG. 5, the transformation of FIG. 4 (blur filter) is configured by a user input to be applied at a rate of 10% every 100 likes. In other examples, the user interface (e.g., 545) may offer a suite of adjustable parameters, enabling configuration of transformation progressions to a fine degree. For instance, the server (e.g., server 106 or 904) may be configured to scale the transformation not only based on likes but also other engagement metrics, such as shares or positive comments, or over fixed or variable time intervals.

In some examples, the transformation increments themselves may be applied in different ways. For example, a cumulative transformation setting, where each new transformation layer intensifies the previous one (e.g., an initial 10% blur followed by an additional 10%, cumulatively reaching 20%), or discretely, where each increment is applied afresh to the original, unaltered media asset (e.g., first applying a 10% blur, then resetting and applying a 20% blur as a new layer).

In certain embodiments, the server (e.g., server 106 or 904) possesses the capability to autonomously set the timing for applying transformations to media assets. This timing may be established independently of the type of transformation selected or, alternatively, it may be synchronized with the process of determining the transformation type itself. For instance, the server might use machine learning algorithms to analyze the content of the media asset and, based on the analysis, simultaneously decide both the nature of the transformation (e.g., such as pixelization for images containing faces and cropping for those with sensitive text) and the most opportune moment for its application. This may mean initiating a transformation immediately after upload, after a certain threshold of user interaction, or at a predetermined time.

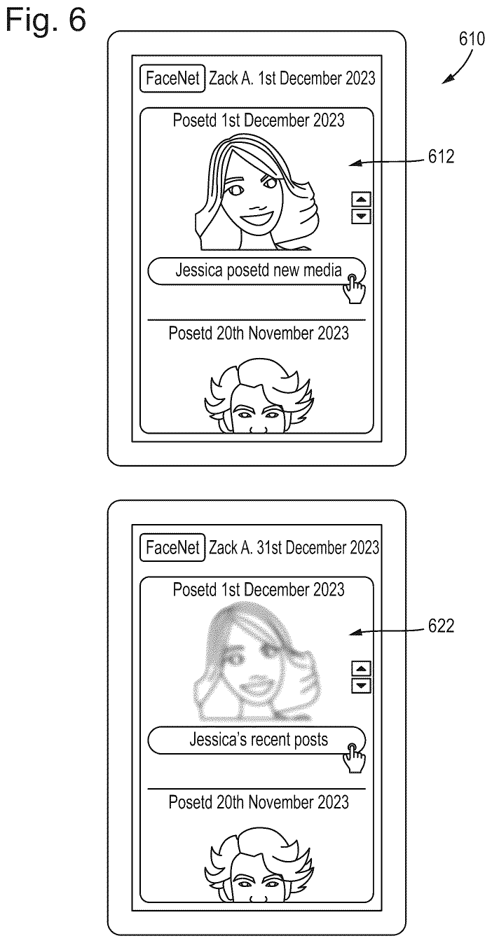

FIG. 6 presents an example user interface on a social media application, where the progressive transformation of a media asset is displayed across different time points. This illustration displays an example user interface on a user device 610, illustrating an example social media feed within the social media application as previously discussed. Media asset 612, shown as an image, is displayed within a social media feed associated with Jessica (i.e., the device is logged into an account of a different user than that of Jessica and is viewing a media uploaded via an account associated with Jessica).

In some examples, the social media feed is configured to facilitate the viewing of media content uploaded within the social media network. The social media feed may display content chronologically, with the newest uploads appearing prominently. In some examples, the newly uploaded image 622 is highlighted at the top of the feed, signaling recent activity. The user interface may include indicators or notifications, such as “Jessica posted new media!”.

In some approaches, upon a lapse of the time period (e.g., 30 days), the social media feed undergoes a transformation, reflected as item 622 of FIG. 6. The same image initially uploaded by an account associated with Jessica now bears a transformation (e.g., a blur filter has been applied). This updated image 612 is a direct consequence of the transformation settings configured (e.g., as per FIG. 5), where the application of the blur filter was scheduled based on user interaction metrics, such as likes, or a predefined time period.

In some embodiments, the blurred image 622 replaces the original image in the feed. It is now the sole version accessible to other devices (and accounts) via the social media network. The blurring effect serves to obscure specific details in the image (e.g., obscuring a facial region identified in the image), thereby enhancing privacy while also reducing the storage footprint on the network's servers.

In certain implementations, once a media asset 612 has been uploaded to the social media network, it may be accessible for download or sharing across various devices, potentially linked to different accounts. For example, an image uploaded via a user account logged in as Jessica might be shared with or downloaded by an account associated with another user (e.g., Zack A.), who may be using the platform from a different device and under a separate account profile.

In some approaches, a previous version of the media asset (e.g., a less transformed version or the original version) may be accessible via the other user account (e.g., account associated with Zack A.), upon completion of a condition (e.g., a transaction). A transactional model may be implemented as part of a tiered subscription system, where different payment levels grant access to varying degrees of transformation reversal. For example, a higher payment tier might provide access to a media asset with only one transformation step applied.

In some approaches, the condition for access to a previous version of the media asset is engagement based. For instance, a server of the social media network (e.g., server 106 or 904) may set social media viewership or interaction targets for each post. Once these targets are met or exceeded (e.g., a certain number of likes, shares, or views), the server may allow an account associated with the other user to access a less transformed version of the media asset.

In some examples, in addition to providing transformed versions of media content items to a plurality of devices via the social network, the server (e.g., server 106 or 904) may offer varying degrees of transformation to different users based on specific parameters, such as the social relationship between them (e.g., via an account or profile logged into the social media network). For instance, a user's close friends or family members may see a less transformed version, whereas acquaintances or the general public might only be able to access a more transformed version.

In some examples of the disclosure, when the media asset 612 is shared (e.g., as a shared item within the social media platform or as a downloaded file to another device) a server associated with the social media network (e.g., server 904 of FIG. 9) may associate metadata to the media asset (i.e., the media asset contains data that it carries with it after being transferred). This metadata may, for example, actively inform the server (e.g., server 904 of FIG. 9) or the receiving device of the transformation settings that were specified by the original uploader (e.g., via instruction imbedded in the metadata) to apply transformations as determined for the originally uploaded media asset.

In some examples, the metadata ensures that the transformation applied to the media asset 612 is persistent. This means that if the original uploader (e.g., Jessica) has set the media asset to incrementally blur over time or upon reaching certain engagement milestones, these transformation processes continue to apply to the media asset aster being shared. Whether the asset resides on the original uploader's device, on a secondary user's device, or within a cloud storage of the social media network, the embedded instructions within the metadata trigger the appropriate transformation at the designated time or event.

For instance, if the media asset 612 is scheduled to undergo a transformation (e.g., a 10% increase in blur with every additional thousand likes it receives), the transformation will occur uniformly wherever the photograph is accessed. For example, if a third-party device downloads the image to a local storage, the local social media application, in conjunction with the device's operating system, may interpret the metadata and continue to apply the blur transformation at the specified rate of likes (e.g., by monitoring the original media asset via the social media network).

In some examples, to further enhance security, the server associated with the social media network (e.g., server 106 or 904) may also opt to remove metadata associated with the media asset. By selectively removing or sanitizing this metadata as part of the transformation process mentioned above, such as when the media asset is shared outside the original platform or downloaded to another device, the server may mitigate potential privacy and security risks associated with the metadata (e.g., location and personal identifier data).

In some embodiments, the transformation process is transparent to the end-users; they witness the change in the media asset's appearance but may not have access to the underlying settings or criteria that triggered the transformation. To the viewers on the social media network, the transition may appear seamless, with the application ensuring that the most updated version of the media asset is the one presented in the social media feed.

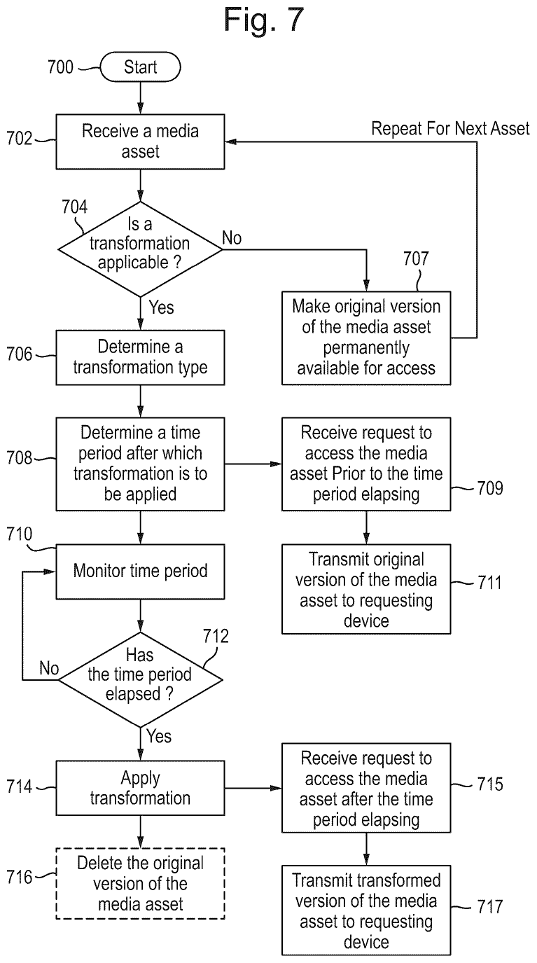

FIG. 7 is a flowchart representing an illustrative process 700 for transforming media assets according to a determined time period, in accordance with some examples of the disclosure. At step 702, Input/Output (I/O) circuitry (e.g., comparable to I/O path 912 in FIG. 9), is engaged to facilitate the reception of a media asset uploaded via a social media network (e.g., comparable to communication network 908 of FIG. 9). The I/O circuitry functions via the social media network to receive a media asset from a user device (e.g., comparable to computing device 902 in FIG. 9), such as smartphones, tablets and personal computers. In some examples, I/O circuitry may utilize temporary storage within the described architecture (e.g., storage 228 and 214 of FIG. 9 or a remote cloud storage) to hold the incoming media asset while it awaits further processing.

In some examples, as shown at step 704, processing circuitry of the server (e.g., processing circuitry 916 in FIG. 9) analyzes the media asset to ascertain if a transformation is warranted based on predefined system criteria or user-established preferences (e.g., if the image contains facial regions or text). It may utilize content recognition algorithms stored within the server's non-transitory memory to analyze the media asset's characteristics. If a transformation is not applicable (e.g., due to the media asset being of a non-distinct object with no identifiable features), control circuitry of the server may retain the original media asset. This action may be facilitated by for example, a long-term data storage capability (e.g., database 206 of FIG. 9).

In some approaches, in addition to the analysis of step 704, control circuitry of the server may also determine the type of transformation to be applied shown at step 706. This may involve employing machine learning models that analyze the media content's attributes (e.g., color histograms, edge detection for images, or frequency analysis for audio) to select a suitable transformation (e.g., pixelization for images, bitrate reduction for audio).

In some embodiments, displayed at step 708, control circuitry of the server determines a time period after which a transformation is to be applied (e.g., via a timing mechanisms embedded within the processing circuitry) to set a schedule for the application of the transformation. This might involve scheduling algorithms that analyze user interaction metrics on the social media network or system calendars on the server or user device.

In some examples, as in step 709, should there be a request to access the uploaded media asset before the transformation is scheduled, communication modules within the I/O path (e.g., I/O path 912 in FIG. 9) may facilitate the retrieval and transmission of the original media asset (e.g., stored in a content database) to be made accessible to the requesting device 711.

In some embodiments such as in step 710, control circuitry of the server monitors the time period set for the transformation. If, as shown at step 712, the control circuitry of the server determines that the time period has elapsed, processing circuitry executes the transformation 714 as per the determined transformation type and time period determined previously (e.g., Gaussian blur for image pixelation, low-pass filters for audio transformation). In some examples of the disclosure, such as in step 716 control circuitry may decide whether to retain or delete the original media asset (e.g., from the storage database).

In some approaches, in response to a request to access the media asset after the time period has elapsed 715, control circuitry of the server may transmit the now-transformed version media asset to the requesting device (e.g., from the content database).

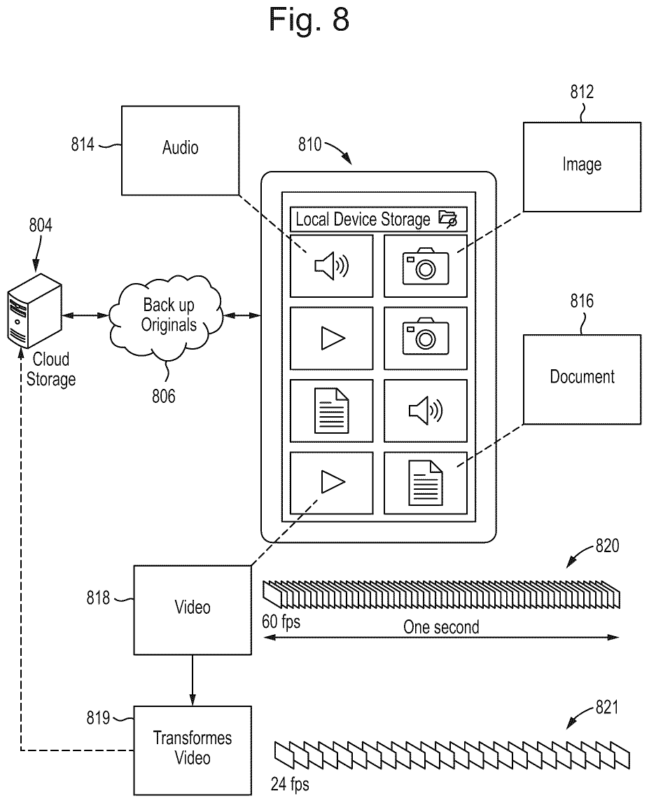

FIG. 8 presents an example scenario illustrating the transformation of media assets stored within the local storage of a user device, in line with managing finite storage resources and maintaining quick access to stored media content. In some examples, this scenario depicted in FIG. 8 exemplifies a system that optimizes local storage usage by replacing original media assets with their transformed counterparts, which consume less space. The original versions of these assets may be concurrently backed up to a secondary storage solution, such as cloud storage, ensuring their availability for future retrieval if necessary.

In the depicted scenario, a user device 810, which could be equipped with processing circuitry comparable to processing circuitry 930 in FIG. 9, manages various media types such as audio 814, image 812, document 816, and video 818. The local storage interface, shown as the device's screen 810, may categorize and display these media assets, allowing users to interact with and manage their content directly.

In some embodiments, the process begins when a media asset, such as audio 814, is not interacted with for a time period. This inactivity may trigger the system, specifically the control circuitry analogous to control circuitry 918 in FIG. 9, to initiate a transformation. The transformation, as discussed in previous examples, may vary based on the media type; for example, audio files might be converted to a lower bitrate format to save space.

In some embodiments, the original, unaltered versions of these assets are transferred to a secure backup storage (e.g., cloud storage 804), facilitated by communication network components comparable to communication network 908 in FIG. 9.

In some approaches of the disclosure, a video file 818 showcases a specific transformation example where the framerate is reduced, as indicated by the progression bars 820 and 821. This reduction in framerate results in a transformed video 819 that maintains a semblance of the original content but with a significantly reduced file size, thus conserving local storage space. The transformed version may act as a visual placeholder, enabling users to recognize and recall the original content without needing to access the backup directly.

In some approaches, such as for images, the transformation may involve reducing resolution or applying compression algorithms that decrease file size while maintaining an identifiable thumbnail or preview of the image. Documents and text files, depicted at 816, might undergo a transformation where only key excerpts or summaries are retained locally, with detailed contents offloaded to the cloud. Similarly, audio files may be down sampled, the audio may be garbled or down mixed or the frequency range modified, retaining only a lower-quality version locally for quick playback, while the high-fidelity original is securely stored in the cloud.

In some examples, the user device's interface, as part of the local device storage, may provide user interface tools to manage these transformations. For example, a preference may be set via user input for how and when each media type is transformed, which may include automatic scheduling transformations based on last access time or manual initiation. The user interface might allow for the specification of the transformation parameters, such as the extent of compression or quality reduction, offering a balance between storage savings and content fidelity.

In some examples of the disclosure, control circuitry within the user device coordinates with cloud storage services to ensure that as soon as a transformation is applied locally, the original version is archived off-device. This synchronization mechanism may leverage networking protocols (e.g., HTTP, FTP) to facilitate data exchange between the device and cloud storage, with the I/O circuitry facilitating data transmission.

In some embodiments, the local transformation process may take place within a pre-existing software framework installed on the user device (e.g., a storage management software of the device), which might be part of the system's firmware or an application running on the operating system. This software framework may be responsible for monitoring media asset interactions, executing transformation protocols, managing local and cloud storage synchronization, and providing a user-interface for configuration and management of the system's functionality.

FIG. 9 is an illustrative block diagram showcasing example system 900 configured for the dynamic transformation and management of media content within a social media network environment. While FIG. 2 depicts system 900 with a specific number and arrangement of components, it should be understood that in some examples, various components of system 900 may be consolidated or integrated. For instance, functionalities attributed to separate devices may be combined within a single user device (e.g., user device 110). System 900 includes a computing device 902, server 904 (e.g., server 106), and a content database 906 (e.g., database 104), all of which are communicatively connected via communication network 908 (e.g., network 102), potentially representing a wide array of interconnected networks including the Internet.

Server 904 is equipped with control circuitry 910 and an input/output (I/O) path 912. Within the control circuitry 910, there is storage 914 and processing circuitry 916. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores). In some examples, processing circuitry may be distributed across multiple separate processors, for example, multiple of the same type of processors (e.g., two Intel Core i9 processors) or multiple different processors (e.g., an Intel Core i7 processor and an Intel Core i9 processor).

Computing device 902, which may take various forms such as a smartphone or tablet, encompasses control circuitry 918, I/O path 920, a speaker 922, a display 924, and a user input interface 926. The latter may provide options for users to manage the transformation settings of their media content. Control circuitry 918 consists of storage 928 and processing circuitry 930. Both control circuitries 910 and 918 may utilize similar processing architectures, capable of handling complex computations as required by the transformation processes.

Storage units 914 and 928, along with any other storage components in system 900 (e.g., within content database 906), function as electronic storage devices for storing not only media content but also metadata and transformation algorithms. Such storage devices can range from solid-state drives to cloud-based storage solutions, depending on the implementation requirements. Control circuitry 910 and 918 may operate based on software instructions stored within these storages. These instructions, when executed, direct the system to perform the dynamic content transformation and management as described herein.

The software architecture can vary, with the application potentially being deployed as a standalone platform on computing device 902, where all necessary instructions and data are stored locally, and updates are received periodically. Alternatively, in a client/server arrangement, computing device 902 may interact with server 904, which hosts the core transformation functionality, distributing the processing workload between the devices.

In the context of a client/server architecture, control circuitry 918 may include communication components enabling interaction with server 904 or other network entities. The application instructions may reside on server 904, with computing device 902 functioning primarily as an interface through which users interact with the system. For example, server 904 may process the transformation instructions and send the resulting data to computing device 902 for display.

User inputs, such as requests to view or interact with transformed media content, are received by control circuitries 910 and 918 through user input interfaces 926, which can be any conventional input method ranging from touchscreens to voice commands. The user interface may also be integrated with display 924, allowing for an interactive experience.

Both server 904 and computing device 902 utilize their respective I/O paths 912 and 920 to exchange data, including media content identifiers, transformation rules, user preferences, and other relevant information. These exchanges facilitate the responsive transformation of media content as it is stored, accessed, and distributed within the social media network.

The processes discussed above are intended to be illustrative and not limiting. One skilled in the art would appreciate that the steps of the processes discussed herein may be omitted, modified, combined and/or rearranged, and any additional steps may be performed without departing from the scope of the invention. For example, steps 225 and 235 of FIG. 2 may be rearranged, combined or omitted altogether. Steps 225 and 247 of FIG. 2 may be performed simultaneously or sequentially. In another example, steps 1,2,3 and 4 of FIG. 3 may be re-arranged or combined. More generally, the above disclosure is meant to be illustrative and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method comprising:
receiving, at a server of a social media network, a media asset for sharing;
providing an original version of the media asset for access by a plurality of devices via the social media network;
determining: (a) an identified type of transformation applicable to the media asset, and (b) a time period after which the identified type of transformation is to be applied;
applying the transformation to the media asset to generate a transformed version of the media asset;
providing the transformed version of the media asset for access by the plurality of devices via the social media network, wherein the transformed version of the media asset requires less storage space than the original version of the media asset; and
wherein the original version of the media asset is unavailable for access by the plurality of devices via the social media network after providing the transformed version of the media asset for access by the plurality of devices via the social media network.

2. The method of claim 1, wherein the determining: (a) the identified type of transformation applicable to the media asset, and (b) the time period after which the identified type of transformation is to be applied comprises:
analyzing, by the server, the original version of the media asset to detect presence of facial regions or presence of text.

3. The method of claim 1, wherein the determining: (a) the identified type of transformation applicable to the media asset, and (b) the time period after which the identified type of transformation is to be applied comprises:
receiving user interface unput specifying: (a) the identified type of transformation applicable to the media asset, and (b) the time period.

4. The method of claim 1, further comprising:
permanently deleting, by the social media network, the original version of the media asset after the time period.

5. The method of claim 1, further comprising:
retaining the original version of the media asset in storage of the social media network after providing the transformed version of the media asset for access by the plurality of devices via the social media network; and
modifying settings of the social media network such that only the transformed version of the media asset is provided to the plurality of devices in response to a request for the media asset.

6. The method of claim 5, further comprising:
modifying the settings of the social media network such that the original version of the media asset is accessible to a device from which the media asset was received for sharing.

7. The method of claim 1, further comprising:
identifying a series of identified sequential transformations, and a set of time periods for applying the series of identified sequential transformations;
applying the series of identified sequential transformations to the media asset in accordance with the set of time periods, wherein each subsequent transformation of the series of identified sequential transformations results in a version of the media asset that requires incrementally less storage space; and
wherein only a most recently transformed version of the media asset is available for access by the plurality of devices via the social media network.

8. The method of claim 7, wherein the identified sequential transformations comprise:
applying a filter that transforms pixel data of the media asset to obscure its content, wherein the filter is configured to transform the pixel data by at least one of altering pixel attributes including one or more of color, brightness, or contrast, or by combining pixels within a defined radius to reduce a granularity of detail in the media asset;
increasing an intensity of the filter with each sequential transformation, wherein the intensity corresponds to a degree of transformation applied to the pixel data; and
determining a maximum intensity level for the filter, wherein the maximum intensity level is reached upon completion of a number of sequential transformation.

9. The method of claim 7, further comprising:
in response to the receiving the media asset for sharing, generating a target stylized representation for the media asset, wherein the generating the target stylized representation comprises:
analyzing the original version of the media asset to identify and extract distinctive visual elements represented as feature vectors; and
generating the target stylized representation by inputting the feature vectors into an image generative machine learning model.

10. The method of claim 1, further comprising:
analyzing the media asset using a facial recognition algorithm to identify one or more facial regions;
segmenting the identified one or more facial regions within the media asset; and
selectively applying the transformation to only the segmented facial regions.

11. The method of claim 1, wherein determining the time period for applying the transformation to the media asset comprises:
monitoring access frequency of the media asset;
determining an access rate based on the monitoring; and
based on the access rate, determining the time period for when to apply the transformation to the media asset.

12. The method of claim 1, further comprising:
embedding metadata associated with the transformation into the transformed version of the media asset prior to providing the transformed version of the media asset for access by the plurality of devices via the social media network;
upon access to the media asset by the plurality of devices via the social media network, retrieving the embedded metadata; and
based on the retrieved metadata, instructing, via the social media network, the plurality of devices accessing the media asset to maintain or reapply the transformation associated with the media asset to ensure consistency of the transformed media asset across the plurality of devices over the time period.

13. A system comprising control circuitry configured to:
receive, at a server of a social media network, a media asset for sharing;
providing an original version of the media asset for access by a plurality of devices via the social media network;
determine: (a) an identified type of transformation applicable to the media asset, and (b) a time period after which the identified type of transformation is to be applied;
apply the transformation to the media asset to generate a transformed version of the media asset;
provide the transformed version of the media asset for access by the plurality of devices via the social media network, wherein the transformed version of the media asset requires less storage space than the original version of the media asset; and
wherein the original version of the media asset is unavailable for access by the plurality of devices via the social media network after providing the transformed version of the media asset for access by the plurality of devices via the social media network.

14. The system of claim 13, wherein the control circuitry is configured to determine: (a) the identified type of transformation applicable to the media asset, and (b) the time period after which the identified type of transformation is to be applied by:
analyzing, by the server, the original version of the media asset to detect the presence of facial regions or text.

15. The system of claim 13, wherein the control circuitry is configured to determine: (a) the identified type of transformation applicable to the media asset, and (b) the time period after which the identified type of transformation is to be applied by:
receiving user interface input specifying: (a) the identified type of transformation applicable to the media asset, and (b) the time period.

16. The system of claim 13, wherein the control circuitry is further configured to:
permanently delete, by the social media network, the original version of the media asset after the time period.

17. The system of claim 13, wherein the control circuitry is further configured to:
retain the original version of the media asset in storage of the social media network after providing the transformed version of the media asset for access by the plurality of devices via the social media network; and
modify settings of the social media network such that only the transformed version of the media asset is provided to the plurality of devices in response to a request for the media asset.

18. The method of claim 17, wherein the control circuitry is further configured to:
modify the settings of the social media network such that the original version of the media asset is accessible to a device from which the media asset was received for sharing.

19. The method of claim 13, wherein the control circuitry is further configured to:
identify a series of identified sequential transformations, and a set of time periods for applying the series of identified sequential transformations;
apply the series of identified sequential transformations to the media asset in accordance with the set of time periods, wherein each subsequent transformation of the series of identified sequential transformations results in a version of the media asset that requires incrementally less storage space; and
wherein only a most recently transformed version of the media asset is available for access by the plurality of devices via the social media network.

20. The method of claim 19, wherein the identified sequential transformations comprise:
applying a filter that transforms pixel data of the media asset to obscure its content, wherein the filter is configured to transform the pixel data by at least one of altering pixel attributes including one or more of color, brightness, or contrast, or by combining pixels within a defined radius to reduce a granularity of detail in the media asset;
increasing an intensity of the filter with each sequential transformation, wherein the intensity corresponds to a degree of transformation applied to the pixel data; and
determining a maximum intensity level for the filter, wherein the maximum intensity level is reached upon completion of a number of sequential transformation.

21.-60. (canceled)
